(19) United States
(12) Patent Application Publication
(10) Pub. No.: US 2026/0274162 A1
(43) Pub. Date: Sep. 17, 2026

(54) DEVICE FOR ADJUSTING A SHELL-SHAPED HOUSING PART, A POSITION DETECTOR FOR USE IN SUCH A DEVICE, AND A VEHICLE PROVIDED WITH SUCH A DEVICE

(71) Applicant: MCi (Mirror Controls International) Netherlands B.V., Woerden (NL)

(72) Inventors: François Roderik Henri BOUAZIZ, Rotterdam (NL); Jeyakrishna SRIDHAR, Woerden (NL); Willem Jacobus Pieter VAN BORTEL, Woerden (NL)

(73) Assignee: MCi (Mirror Controls International) Netherlands B.V., Woerden (NL)

(21) Appl. No.: 19/469,557

(22) PCT Filed: Mar. 28, 2024
(86) PCT No.: PCT/NL2024/050156

§ 371 Date: Sep. 26, 2025

(30) Foreign Application Priority Data
Mar. 29, 2023 (NL) 2034459

(51) Int. Cl. B60R 1/074; G06F 3/045

(52) U.S. Cl. CPC B60R 1/074; G06F 3/045

(57) ABSTRACT

The invention relates to a device for adjusting a shell-shaped housing part, for example a mirror cap. The device, in particular an exterior mirror device, comprises a base part on which, using a first hinge construction, a supporting frame is arranged. Further, the device comprises, for example, a first actuator. The supporting frame is pivotable, in a pivoting range, relative to the base part about a first hinge axis extending in a substantially upward direction, between a folded-in position and a folded-out position, for instance using a first actuator. Furthermore, the device is provided with a position detector having a voltage divider of which at least a part of the range substantially corresponds to the pivoting range of the supporting frame.

The invention relates to a device for adjusting a shell-shaped housing part, such as, for example, a mirror cap. In particular, such a device forms a mirror device or a so-called mirror adjuster, more particularly an interior mirror device or an exterior mirror device, such as, for example, an exterior mirror device for a motor vehicle. The device comprises a base part, in particular for attachment to the body of the motor vehicle, on which, using a hinge construction, a supporting frame is arranged, such that the supporting frame is pivotable, in a pivoting range, relative to the base part about a hinge axis extending in a substantially upward direction, for instance using a, for example electric, actuator, between a folded-in position, in which the supporting frame, for instance, substantially abuts along the body of the motor vehicle, and at least one folded-out position, in which the supporting frame, for instance, is oriented substantially transversely to the body, furthermore comprising a position detector for determining a pivoting position of the supporting frame relative to the base part.

A device of this type is known, for instance, from patent publication NL2013771 and can be used, for instance, to rotate a shell-shaped housing part mounted on the supporting frame, such as, for example, a mirror cap, from a parking position to a use position. Usually, on the supporting frame, a mirror adjuster is provided for fine-tuning the position of a mirror surface held by the mirror adjuster. To that end, the mirror adjuster mounted on the supporting frame usually comprises an adjustment actuator to enable the mirror surface to be adjusted or fine-tuned to some extent about a substantially vertical adjustment axis. In order for the position of the housing part to be determined during fine-tuning, the position detector is configured for determining a pivoting position of the supporting frame relative to the base part during a limited portion of the rotation route between the folded-in position and the folded-out position.

The above-mentioned device can advantageously offer functionality that is attractive for a user, for instance in that the supporting frame, after rotation, can be returned again to a previously determined pivoting position, for example a use position.

It is desirable to provide a device, in particular a mirror device, that can offer supplementary functionality.

The invention contemplates the provision of an alternative device, in particular an exterior mirror device. In particular, the invention contemplates the provision of an improved device. More particularly, the invention contemplates the provision of a device of the type described in the opening paragraph hereof, wherein, preferably with preservation of one or more of the advantages, disadvantages can be counteracted and/or functionality can be augmented.

To this end, the position detector comprises a voltage divider of which at least a part of the range thereof substantially corresponds to the pivoting range of the supporting frame.

By configuring the position detector such that the pivoting range of the supporting frame corresponds to at least a part of the range of the detector, in principle any pivoting position of the supporting frame in its pivoting range can be determined, not just in the limited fine-tuning range in a use position. Thus, the supporting frame can, from any position, be simply, rapidly and energetically efficiently brought to another, desired angular position.

The term voltage divider is understood to mean a structure that is configured for generating a partial voltage depending on a registered position in a range of the voltage divider, such as a potentiometer, called potmeter for short.

Preferably, the voltage divider has a nonlinear dependency in the pivoting range of the supporting frame, so that the sensitivity of the position detector can be augmented in a range of interest, for instance in a folding-out range around the folded-out position, or in the folding-out range and a folding-in range in the folded-in position.

In a practical implementation, the voltage divider has a potentiometer with a resistance track and a runner, coupled to the supporting frame or the base part, provided with a sliding contact which upon pivoting of the supporting frame moves in electrical contact along the resistance track. The resistance track can be, for example, circular segment-shaped or elongate.

The potentiometer can furthermore comprise a guiding track, while the runner is provided with a pair of sliding contacts of which a first sliding contact, coupled to the supporting frame or the base part, upon pivoting of the supporting frame, moves in electrical contact along the resistance track, and a second sliding contact, mechanically and electrically connected with the first sliding contact, upon pivoting of the supporting frame, moves in electrical contact along the guiding track.

Advantageously, the resistance track has in an area substantially corresponding to the folding-out range around the folded-out position a greater electrical resistance per unit length in a direction along the resistance track than in an area substantially corresponding to a range outside the folding-out range. Thus the voltage divider has a greater voltage gradient in the folding-out range.

The greater electrical resistance per unit length along the resistance track can for instance be realized by implementing the resistance track in the area concerned with a smaller cross section than outside thereof, for instance by using a thinner or narrower profile. Also, material having a lower electric conductivity may be used in the area concerned of the resistance track.

Furthermore, the device can comprise a support arranged on the supporting frame using a second hinge construction, in particular for supporting a mirror surface or other element, such as a camera, display and/or a floodlight or other light source, such that the support is pivotable relative to the supporting frame, for instance using a second, for example electric, actuator, while the support is pivotable relative to the supporting frame only about a second hinge axis extending substantially transversely to the substantially upward direction, and wherein the position detector comprises a second voltage divider for determining a pivoting position of the support relative to the supporting frame. By application of the second hinge construction, the mirror surface is adjustable in at least two degrees of freedom, while the second voltage divider is able to determine the pivoting position of the support relative to the supporting frame.

The position detector can comprise a supporting unit, for instance implemented as a printed circuit board, on which preferably both the first voltage divider and the second voltage divider are arranged, so that measured voltage values of the voltage dividers can be simply and reliably processed. Naturally, the first and second voltage divider can alternatively be arranged on separate supporting units, for instance to simplify complexity in the design of the supporting units.

In an implementation of the device, the supporting frame is pivotable relative to the base part between the folded-in position, in which the supporting frame, for instance, substantially abuts along the body of the motor vehicle, via the folded-out position, in which the supporting frame, for instance, is oriented substantially transversely to the body, and an overfold position, in which the supporting frame is pivoted beyond the folded-out position, thus forming an emergency folded-in position for the purpose of, for instance, a cyclist or pedestrian colliding with or bumping against the shell-shaped housing part.

Advantageously, an area of the resistance track that substantially corresponds to a folding-in range near the folded-in position or an overfold range near the overfold position, is in electrical contact with an electrically conductive path which is directly, via an extra resistance track or via an electric resistance, connected to an end of the resistance track. Thus, the voltage gradient in the area can be relatively small or may even disappear practically entirely, so that the voltage range of the voltage divider can be largely utilized for accurately measuring the pivoting position in the area or areas that correspond to the pivoting range and/or pivoting ranges of interest such as the folding-out range and/or the folding-in range.

The invention also relates to a position detector configured for use in such a device.

The invention furthermore relates to a vehicle provided with such a device.

Further advantageous embodiments of the invention are represented in the dependent claims.

The invention will be further elucidated on the basis of exemplary embodiments represented in the drawing. In the drawing:

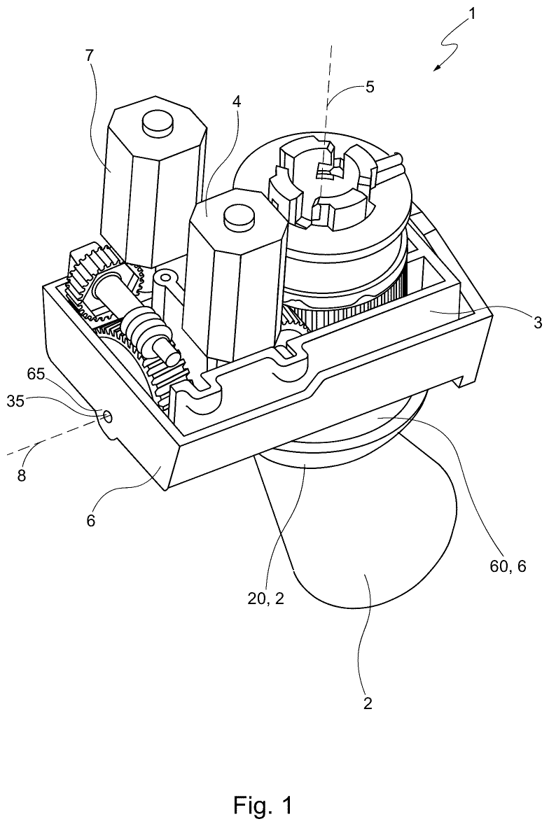

FIG. 1 shows a schematic perspective view of a partly cutaway device according to an aspect of the invention;

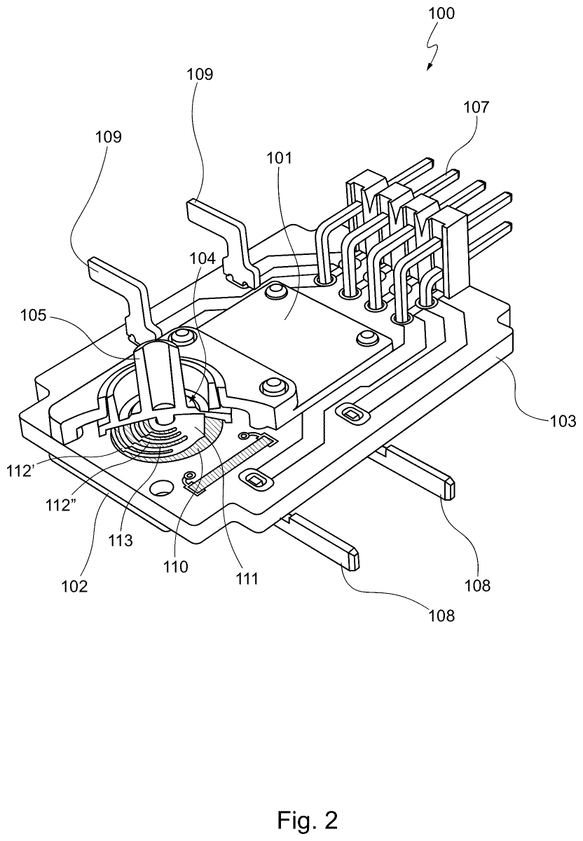

FIG. 2 shows a schematic perspective view of a position detector according to an aspect of the invention for use in the device of FIG. 1;

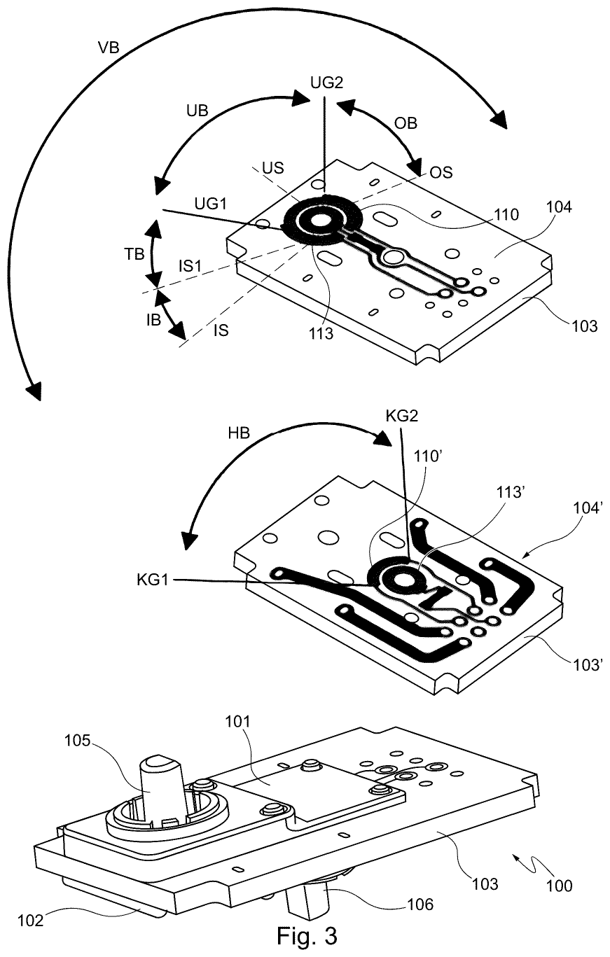

FIG. 3 shows a schematic perspective top view and bottom view of a supporting unit of the position detector of FIG. 2, as well as a schematic perspective view of the supporting unit on which a first and second voltage divider are arranged;

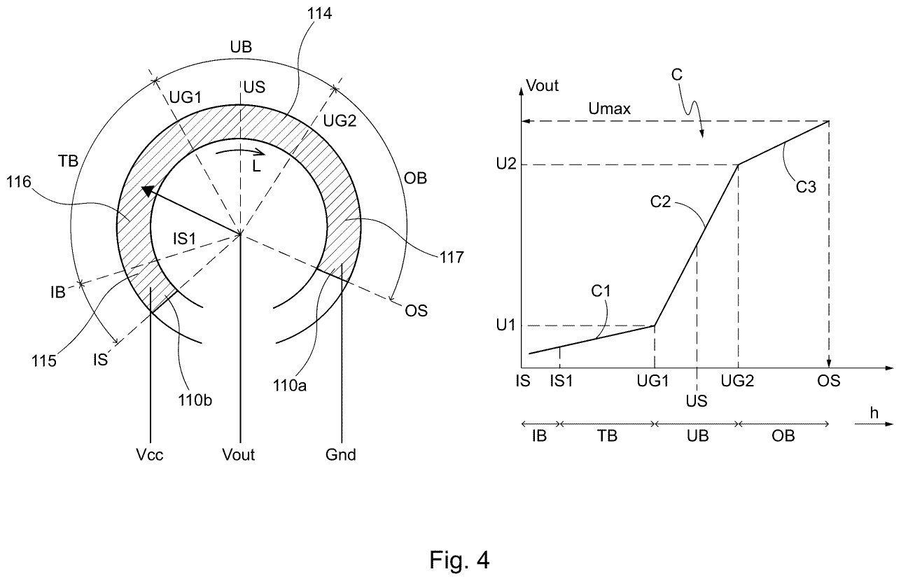

FIG. 4 shows a schematic top view of a potentiometer of the first voltage divider of FIG. 3, as well as a graphic representation of an output voltage of the potentiometer;

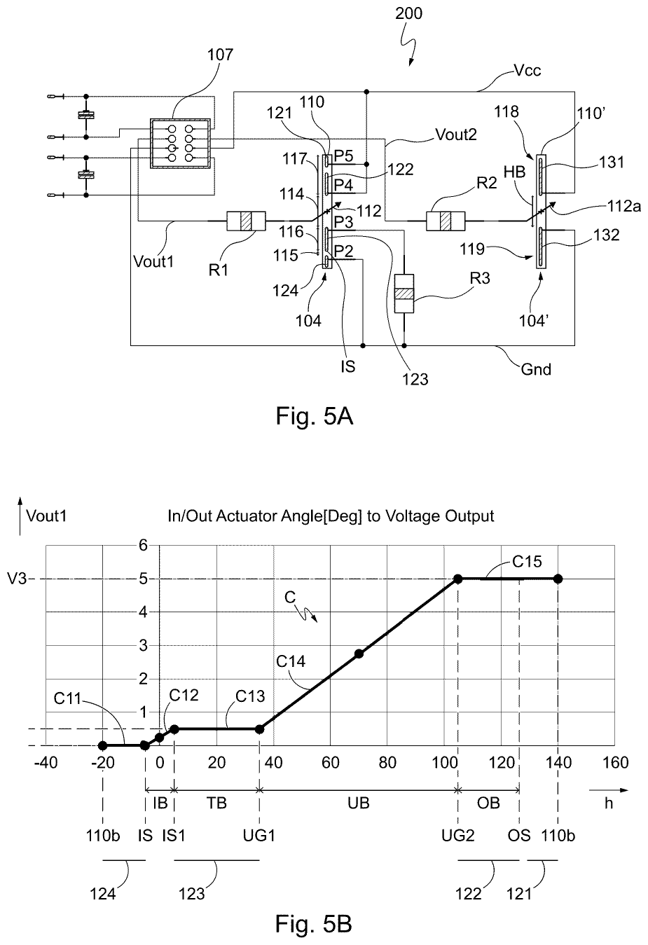

FIG. 5A shows a schematic view of an electric circuit of another position detector according to an aspect of the invention;

FIG. 5B shows a graphic representation of an output voltage of a first voltage divider of the position detector of FIG. 5A;

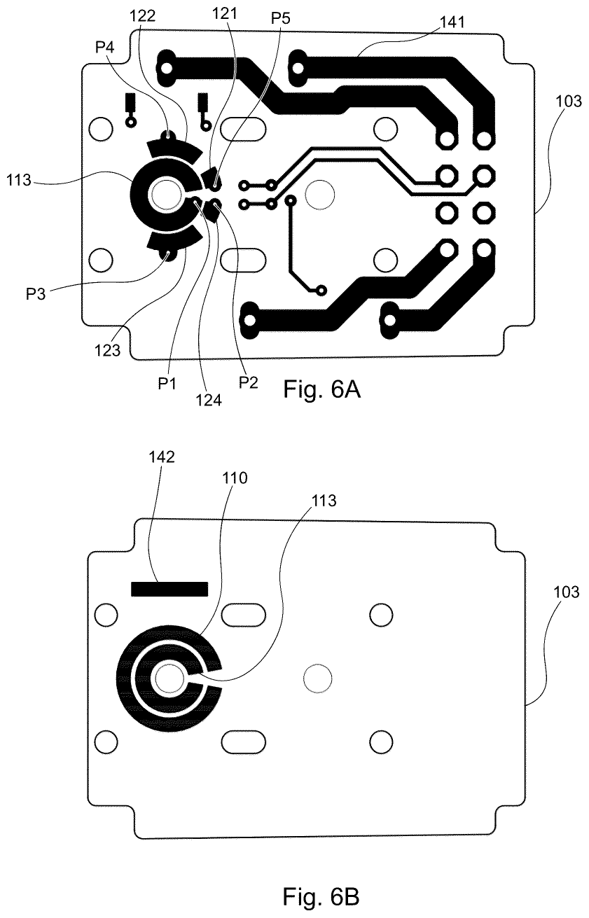

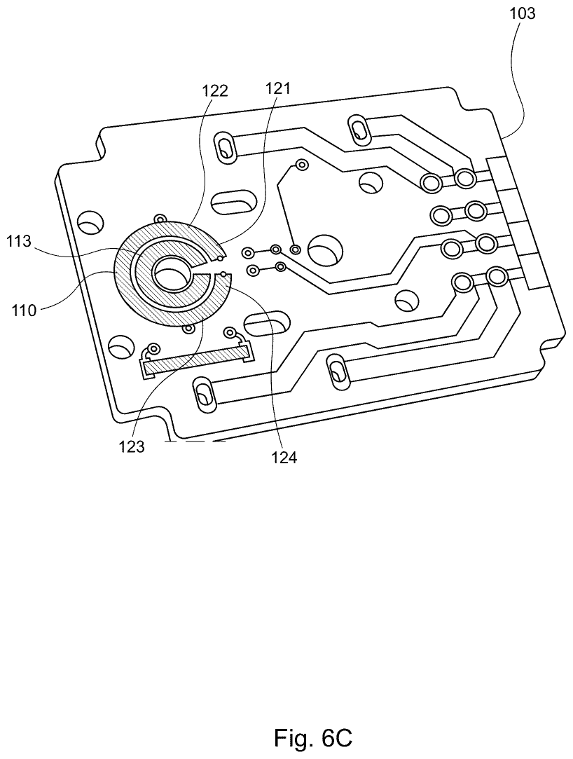

FIG. 6A shows a schematic top plan view of a copper pattern on a supporting unit of the position detector of FIG. 5A;

FIG. 6B shows a schematic top plan view of a carbon pattern on the supporting unit of FIG. 6A, and

FIG. 6C shows a schematic perspective top plan view of the supporting unit of FIG. 6A with copper pattern and carbon pattern.

The drawing shows merely schematic representations of preferred embodiments of the invention. In the figures, like or corresponding parts are designated with the same or corresponding reference numerals.

FIG. 1 shows a schematic perspective view of a partly cutaway device 1 according to an aspect of the invention. The device 1 may for instance be configured for adjusting a shell-shaped housing part, such as, for example, a mirror cap, in particular a mirror device or a so-called mirror adjuster, more particularly an interior mirror device or an exterior mirror device for a motor vehicle.

The device 1 comprises a base part 2, in particular for attachment to the body of the motor vehicle. The device 1 furthermore has a first hinge construction 25, 60 and a second hinge construction 35, 60, 65. With the aid of the first hinge construction 25, 60 a supporting frame 3 is arranged on the base part 2. The device 1 comprises a first actuator 4, for example an electric actuator 4, with which the supporting frame 3 is pivotable, in a pivoting range, relative to the base part 2 about a first hinge axis 5 extending in a substantially upward direction, between a folded-in position, in which the supporting frame 3, for instance, substantially abuts along the body of the motor vehicle, and at least one folded-out position, in which the supporting frame 3, for instance, is oriented substantially transversely to the body.

It is noted that the folded-out position can be, for instance, a use position of an exterior mirror device and that the folded-in position can be, for instance, a parking position, in which the device 1 and/or a mirror cap possibly provided therein or thereon, for instance in lateral direction, projects less far relative to the body.

With the aid of the second hinge construction 35, 60, 65, on the supporting frame 3 a support 6 is arranged. It is noted that the first and second hinge constructions should not be separate constructions, but, for instance, may be partly formed by an integrated construction, such as, for example, a double ball hinge 20, 60.

In particular, the support 6 may be configured for directly or indirectly supporting a mirror surface. For instance, the support 6 may be configured for, substantially fixedly or rigidly, mounting a mirror glass thereon. Alternatively, for instance, a mirror surface may be coated onto the support 6. While the support 6 may be suitable in particular for supporting a mirror surface, the support 6 may, in alternative embodiments, for instance alternatively or additionally, be suitable for supporting one or more alternative elements, in particular elements to enable a driver of a vehicle to at least partly observe areas located behind and/or next to him, such as, for example, a camera and/or a display, and/or a floodlight or other light source. Such elements may, for instance, at least partly be surrounded by a shell-shaped housing part provided on or by the support 6.

Furthermore, the device 1 comprises a second actuator 7, preferably an electric actuator 7. With the aid of this second actuator 7, the support 6 is pivotable relative to the supporting frame 3.

It is noted that the support 6, and a mirror surface possibly supported thereon, is pivotable relative to the supporting frame 3 only about a second hinge axis 8 extending substantially transversely to the substantially upward direction. The support 6 and/or the mirror surface, if present, can then, for instance, to some extent be rotated forwards and/or backwards relative to the supporting frame 3, but then cannot, for instance, be adjusted relative to the supporting frame 3 between a position in which the mirror surface runs more parallel to the body of the vehicle and a position in which the mirror surface is more transverse to the body of the vehicle.

It is noted that the first and the second hinge axes 5, 8 can be virtual axes. Furthermore, it is noted that the hinge axes 5, 8 may be placed substantially transverse to each other, for instance perpendicular to each other. Additionally or alternatively, these (virtual) hinge axes 5, 8 may substantially intersect each other, most preferably in a center of the double ball hinge 20, 60.

In preferred embodiments, the support 6 can extend at least partly around the supporting frame 3.

It is noted that the support 6 can form a shell-shaped housing part, such as, for instance, a mirror cap or part of a housing for a camera, or can be an integral part of a housing part, such as a mirror cap.

Alternatively, the support 6 may be configured to be provided with a shell-shaped housing part to be fixedly or rigidly mounted on the support 6.

Preferably, a possibly present mirror cap or other shell-shaped housing part may be provided fixedly or rigidly, that is, substantially immovably, on the support 6.

Additionally or alternatively, a mirror surface, which may, for instance, be formed by a mirror glass, may be provided fixedly or rigidly, that is, substantially immovably, on the support 6.

Accordingly, the mirror surface and the shell-shaped housing part can both be fixedly or rigidly provided on the support 6 and one or both may form an integral part of the support.

In an embodiment, the mirror surface may then, together with the shell-shaped housing part, form a substantially closed housing which extends substantially around the supporting frame 3 and which can be moved relative to the supporting frame 3 about the second hinge axis 8, which can preferably extend in a substantially horizontal direction. Furthermore, the housing, together with the supporting frame 3 substantially located within it, can be moved relative to the base part 2 about the first, preferably substantially vertical, hinge axis 5.

In an alternative embodiment, it can be the supporting frame 3 that supports a shell-shaped housing part, such as a mirror cap. The supporting frame 3 can then, for instance, be formed integrally with the shell-shaped housing part, or may be configured to be provided with a shell-shaped housing part, such as a mirror cap, to be fixedly or rigidly mounted on the supporting frame 3. Just as in the above-described embodiment, in this alternative embodiment also, the mirror surface may be fixedly or rigidly, that is, substantially immovably, provided on the support 6. An opening may then be provided in the housing part, so that the mirror surface is at least partly visible. In such an embodiment, the housing part, for instance the mirror cap, together with the supporting frame 3, can be moved relative to the base part 2 about the first, preferably substantially vertical, hinge axis 5. However, because the supporting frame 3 cannot be moved relative to the base part 2 about another hinge axis, in particular not about a substantially horizontal hinge axis 8, external loads that load the housing part during use, such as wind, can only tend to undesirably rotate the housing part coupled to the supporting frame 3 about the first hinge axis 5. Accordingly, such external loads on the housing part then will not tend to rotate the housing part, preferably the mirror cap, about a substantially horizontal axis. Since in such an embodiment the mirror surface not substantially fixedly or rigidly connected with the housing part can be held out of the driving wind by this housing part, the device 1 needs to hold the support 6 provided with the mirror surface less stiffly relative to the supporting frame 3 than the device 1 should hold the supporting frame 3 with the shell-shaped housing part substantially fixedly or rigidly provided thereon, and during use possibly loaded relatively heavily. In the case where the second actuator 7 and a second drive train, if present, have to be suitable to overcome a force, for example a frictional force, with which the support 6 is restrained relative to the supporting frame 3 from unwanted rotation, the second actuator 7 in such an embodiment can be made of relatively light, and hence, for instance, relatively compact and/or inexpensive, design. This is because the force to be overcome can thus be relatively limited in the case where the support 6 provided with the mirror surface can be kept out of the wind at least partly by the shell-shaped housing part which is then placed not on the support 6, but on the supporting frame 3.

In embodiments, the supporting frame 3 may be placed movably relative to the base part 2 using a first ball hinge construction 30, 60. This does not mean, however, that the supporting frame 3 needs to have two degrees of freedom relative to the base part and/or that the supporting frame 3 needs to be able to rotate relative to the base part 2 about two axes. This is because the device 1 can preferably be configured such that the supporting frame 3 can rotate only about the first hinge axis 5 relative to the base part 2. Also, in principle, the device 1 can be equipped without the second hinge construction.

Additionally or alternatively, the support 6 may be mounted movably relative to the supporting frame 3 with the aid of a second ball hinge construction 30, 60. This does not mean, however, that the movement of the support 6 relative to the supporting frame 3 should then have two degrees of freedom of movement and/or that the support 6 needs to be able to rotate relative to the supporting frame about two axes. In fact, as already stated, the support 6, possibly together with a mirror surface possibly supported thereon, is pivotable relative to the supporting frame 3 only about the second hinge axis 8. The supporting frame 3 and the support 6 may, for instance to that end, be provided with cooperating hinge means 35, 65, which can for instance comprise a rotatably suspended shaft 35, to have the support 6 and the supporting frame 3 rotate about the second (virtual) hinge axis 8, as is also the case, for instance, in the exemplary embodiment shown in FIG. 1.

In the embodiment shown, the pivoting range is such that the supporting frame 3 is pivotable relative to the base part 2 in the pivoting range between the folded-in position, in which the supporting frame 3, for instance, substantially abuts along the body of the motor vehicle, via the folded-out position, in which the supporting frame 3, for instance, is oriented substantially transversely to the body, and an overfold position, in which the supporting frame 3 has been pivoted beyond the folded-out position when such is desirable, for instance when a cyclist or pedestrian or an object collides with the mirror cap, if present, or other shell-shaped housing part. In this manner, upon emergency operation, that is, for instance, upon collision with a cyclist, pedestrian or object, the supporting frame 3, and hence also the support 6 coupled thereto and the mirror cap, if present, or other shell-shaped housing part, can pivot about the first hinge axis 5 from the folded-out position to an emergency fold-in position, which can, for instance, substantially correspond to the folded-in position or parking position, or which may, conversely, be formed, for instance, by a so-called overfold position OS when the pedestrian or cyclist, for instance, bumps against or collides with the mirror cap or other shell-shaped housing part.

The pivoting range VB of the supporting frame 3 relative to the base part 2 preferably comprises a folding-out range UB around the folded-out position US, see also the description hereinafter with reference to FIG. 3 and FIG. 4. The folding-out range UB usually extends with a relatively small angle around the folded-out position US, between a first fold-out limit angle UG1 and a second fold-out limit angle UG2, for instance from about −15°, −12°, −10° or −8°relative to the folded-out position US, to about +15°, +12°, +10° or +8° relative to the folded-out position US. By making the angle of the supporting frame 3 settable in the folding-out range UB around the folded-out position, the requirements or wishes of, for example, a user of a vehicle can be met. The folding-out range UB thus forms a relatively small fine-tune angular range.

Likewise, the support 6 can be adjustable relative to the supporting frame 3, but preferably through an angular range HB that is greater than the folding-out range UB in the pivoting range VB of the supporting frame 3 relative to the base part 2. However, advantageously, the support 6 can be adjustable through a relatively large angular range HB, for instance, through minimally 90°, 120° or 160°, so that, for instance, the mirror glass can be rotated such that a driver of a vehicle, via the mirror glass, can see the ground, a gutter, or a curbstone next to the vehicle, for instance when parking.

The device 1 includes furthermore a position detector 100 for determining a pivoting position of the supporting frame 3 relative to the base part 2.

FIG. 2 shows a schematic perspective view of a position detector 100 according to an aspect of the invention for use in the device 1 of FIG. 1.

The position detector 100 as shown in FIG. 2 is provided with a first voltage divider 101 of which at least a part of its range substantially corresponds to the pivoting range of the supporting frame 3 relative to the base part 2. The position detector shown is further provided with a second voltage divider 102 for determining a pivoting position of the support 6 relative to the supporting frame 3. The position detector 100 comprises a supporting unit which in the embodiment shown is implemented as a printed circuit board 103 on which the first voltage divider 101 and the second voltage divider 102 are arranged. In FIG. 2 the first voltage divider 101 is partly cutaway. The first voltage divider 101 shown has a potentiometer 104 which has a sensor axis or sensor shaft 105, while the device 1 is furthermore configured for rotating said sensor axis or sensor shaft 105 during pivoting of the supporting frame 3 relative to the base part 2. A basic structure of such a potentiometer is for instance described in Dutch patent application NL 2 012 808 which is incorporated herein by reference. The second voltage divider 102 likewise has a potentiometer with a sensor axis or sensor shaft 106, while the device 1 is furthermore configured for rotating the sensor axis or sensor shaft 106 during pivoting of the support 6 relative to the supporting frame 3, see also FIG. 3. Furthermore, the position detector 100 has a connector unit 107 for electrical connection with corresponding connectors of the device 1, for instance for connection to electric supply, transmission channels for sensor data and/or actuator control signals, etc. Also, the position detector 100 has separate connectors 108, 109 for connection to the first and second actuator 4, 7, respectively. In alternative embodiments, the electric connection between the position detector 100 and the device may be realized differently, for instance, exclusively via a single connector unit.

The potentiometer 104 of the first voltage divider 101 has a resistance track 110 with an electrical resistance. During operation of the device 1, the resistance track 110 is connected at the ends 110a,b to mutually different potentials, such as a supply voltage Vcc and an electric ground Gnd, to generate a voltage course or gradient along the resistance track. Also, the potentiometer 104 has a runner 111, coupled to the supporting frame 3 or the base part 2 and provided with a sliding contact 112 which upon pivoting of the supporting frame 3 moves in electrical contact along the resistance track 110, for measuring at the electrical contact 112 a voltage value Vout which is representative of the momentaneous pivoting position of the supporting frame 3.

In the embodiment shown, the first voltage divider 101 further has a guiding track 113 having an electrical resistance that is small with respect to the resistance of the resistance track 110. Furthermore, the runner 111 of the potentiometer 104, in the embodiment shown, is provided with a pair of sliding contacts 112′, 112″, of which a first sliding contact 112′, coupled to the supporting frame 3 or the base part 2, upon pivoting of the supporting frame 3, moves while in electrical contact along the resistance track 110, as described hereinabove, and of which a second sliding contact 112″, mechanically and electrically connected with the first sliding contact 112′, upon pivoting of the supporting frame 3, moves while in electrical contact along the guiding track 113. Thus, the voltage value Vout measured by the first sliding contact 112′ can be registered via the second sliding contact 112″.

In the embodiment shown, both the resistance track 110 and the guiding track 113 are circular segment-shaped, with a mutually different curvature radius. In another embodiment, the resistance track and/or the guiding track may be shaped otherwise, for example, of elongate shape.

Also the second voltage divider 102 has such a potentiometer 104′ implemented with a second resistance track 110′ and a second guiding track 113′.

FIG. 3 shows a schematic perspective top view (FIG. 3, top) and bottom view (FIG. 3, center) of the supporting unit 103 of the position detector 100 of FIG. 2, as well as a schematic perspective view (FIG. 3, bottom) of the supporting unit 103 on which the first and second voltage divider 101, 102 are arranged.

FIG. 4 shows a schematic top view of a potentiometer of the first voltage divider of FIG. 3 on the left-hand side of FIG. 4, as well as a graphic representation of an output voltage Vout of the potentiometer 104 on the right-hand side of FIG. 4.

At the top of FIG. 3, the resistance track 110 and the guiding track 113 of the potentiometer 104 of the first voltage divider 101 are visible on the supporting unit. Likewise, FIG. 3 shows, in the center, the resistance track 110′ and the guiding track 113′ of the potentiometer 104′ of the second voltage divider 102 on the supporting unit 103.

In FIG. 3 and FIG. 4, positions, angles and (angular) ranges of the first voltage divider 101 and the second voltage divider 102 are shown such as they correspond with corresponding positions, angles and (angular) ranges of the supporting frame 3 relative to the base part 2, and of the support 6 relative to the supporting frame 3, respectively.

As described hereinabove, the pivoting range VB of the supporting frame 3 relative to the base part 2 has a folding-out range UB which extends between the first fold-out limit angle UG1 and the second fold-out limit angle UG2, around the folded-out position US. The pivoting range VB further includes a folded-in position IS and a folding-in range IB which extends between the folded-in position IS and a fold-in limit angle IS1. The angle between the first fold-out limit angle UG1 and the folded-out position US is for instance approximately 15°, 12°, 10° or 8°. Likewise, the angle between the second fold-out limit angle UG2 is for instance approximately 15°, 12°, 10° or 8°. Between the folding-out range UB and the folding-in range IB is an intermediate range TB. In addition, the pivoting range VB has an overfolding range OB which extends between the folding-out range UB and the overfold position OS. The folding-in range IB, the intermediate range TB, the folding-out range and the overfold range OB substantially link up with each other in succession, thus forming the pivoting range VB of the supporting frame 3 relative to the base part 2.

The positions, angles and ranges of the pivoting range VB correspond with, respectively, positions, angles and ranges in the corresponding pivoting range of the first voltage divider 101 as represented at the top of FIG. 3. In principle, each angle of the pivoting range VB of the supporting frame corresponds uniquely with an angle of the pivoting range of the first voltage divider 101, and vice versa.

The angular range HB of the support 6 relative to the supporting frame 3 is greater than the folding-out range UB of the supporting frame 3 relative to the base part 2. As described hereinabove, the angular range can be 90°, 120° or 160° at a minimum, and extend between a first tilt limit angle KG1 and a second tilt limit angle KG2.

The angles and ranges of the angular range HB correspond with angles and ranges, respectively, in the corresponding angular range of the second voltage divider 102 as represented in the center of FIG. 3. In principle, each angle of the angular range VB of the supporting frame corresponds unequivocally with an angle of the angular range of the second voltage divider 102, and vice versa.

As shown at the top in FIG. 3, at least a part of the pivoting range of the first voltage divider 101 corresponds to the pivoting range VB of the supporting frame 3. The whole pivoting range VB of the supporting frame 3 is depicted on the pivoting range of the first voltage divider 101. As shown in the middle of FIG. 3, likewise, at least a part of the angular range of the second voltage divider 102 corresponds to the angular range HB of the support 6. Also the whole angular range HB of the support 6 is depicted on the angular range of the second voltage divider 102.

In the embodiment shown, the position detector 100 has, in the folding-out range UB extending between the first fold-out limit angle UG1 and the second fold-out limit angle UG2, around the folded-out position US, a greater sensitivity than outside the folding-out range UB. As a consequence of this, a pivoting position in the folding-out range UB can be determined relatively accurately, so that a folded-out position US desired by a user can be set relatively accurately.

With reference to FIG. 4, the resistance track 110 of the first potentiometer has, in a range 114 substantially corresponding to the folding-out range UB around the folded-out position US, a greater electrical resistance per unit length in a length direction L along the resistance track 110 than in an area substantially corresponding to a range outside the folding-out range UB. Thus, material forming the resistance track 110 in the area 114 substantially corresponding to the folding-out range UB can have a greater electrical resistance than material forming the resistance track 110 outside the folding-out range UB. In the implementation shown in FIG. 4, the area 114 corresponding to the folding-out range UB is formed by a first material, and the remaining area of the resistance track 110, such as an area 115 corresponding to the folding-in range IB, an area 116 corresponding to the intermediate range TB, and an area 117 corresponding to the overfold range OB, is formed by a second material, with the electric conductivity of the first material being lower than the electric conductivity of the second material. It is noted that the first and/or second material can contain a mixture of substances or just one substance. Also, the material may be applied as a homogeneous layer or with an inhomogeneous structure, for instance with a periodic structure.

Additionally or alternatively, the area 114 of the resistance track 110 that substantially corresponds to the folding-out range UB along the length direction L of the resistance track 110 can have a smaller cross-sectional surface than in an area 115, 116, 117 substantially corresponding to a range outside the folding-out range UB. By implementing the cross-sectional surface to be smaller, for instance, narrower or less deep, a resistance track 110 can be obtained that at the area 114 corresponding to the folding-out range UB has a greater electrical resistance per unit length in the length direction L.

As represented on the right-hand side of FIG. 4, the voltage value or output voltage Vout, as registered by the contact points 112, as a function of the pivoting angle h of the supporting frame 3 increases strictly monotonically, has an ascending flank throughout, so that each registered voltage value can be uniquely related to an associated pivoting angle of the supporting frame 3. Due to the variation in electrical resistance along the resistance track 110, the curve C of the output voltage Vout has in the area 114 corresponding to the folding-out range UB a greater slope or gradient than outside of it. Specifically, a first curve segment C1, at the area 115 corresponding to the folding-in range IB and the area 116 corresponding to the intermediate range TB, has a first slope or gradient. A second curve segment C2, linking up with the first curve segment C1, at the area 114 corresponding to the folding-out range UB, has a second slope or gradient that is greater than the first slope or gradient. A third curve segment C3, linking up with the second curve segment C2, at the area 117 corresponding to the overfold range OB, has a third slope or gradient that is smaller than the second slope or gradient, and may be equal to the first slope or gradient.

Where the slope or gradient of the curve C is greater, a pivoting angle of the supporting frame 3 can be advantageously determined more accurately because a deviation in the pivoting angle brings about a relatively large change of the registered output voltage Vout. Here, advantageously, use is made of the nonlinear dependence of the voltage divider as a function of the pivoting angle of the supporting frame.

FIG. 5A shows a schematic view of an electric circuit 200 of another position detector 100 according to an aspect of the invention. FIG. 5B shows a graphic representation of an output voltage Vout1 of a first voltage divider 101 of the position detector 100 of FIG. 5A.

The electric circuit 200 shows in schematic form a position detector 100 largely similar to the position detector 100 as described with reference to FIGS. 2-4. The electric circuit 200 includes the first potentiometer 104 with associated resistance track 110 and contact points 112, as well as the second potentiometer 104′ with associated resistance track 110′ and contact points 112a. The contact points 112, 112a of the two potentiometers 104, 104′ are connected via a first measuring resistance R1 and a second resistance R2, respectively, to terminal points of the connector unit 107. Other terminal points of the connector unit 107 are connected to a supply line Vcc, an electric ground line Gnd and control lines M1_A, M1_B, M2_A, M2_B for the first and second actuators 4, 7.

The first potentiometer 104 includes supplementary electrically conductive paths 121, 122, 123, 124 which are in electrical connection with areas of the resistance track 110, as described in more detail hereinafter, with reference to FIGS. 5A and 6A.

A first supplementary electrically conductive path 121 is near the first end 110a of the resistance track 110, and is in electrical contact with said first end 110a. A second supplementary electrically conductive path 122 is near the area 117 of the resistance track 110 that corresponds to the overfold range OB of the supporting frame 3, and is in electrical contact at least with the greater part of said area 117. A third supplementary electrically conductive path 123 is near the area 116 of the resistance track 110 that corresponds to the intermediate range TB of the supporting frame 3, and is in electrical contact at least with the greater part of said area 116. A fourth supplementary electrically conductive path 124 is near the second end 110b of the resistance track 110, and is in electrical contact with said second end 110b.

Each of the supplementary electrical paths 121-124 includes a respective electrical terminal P5, P4, P3, P2. The supplementary electrically conductive paths 121-124 have a circular segment-shaped profile, in the embodiment shown. However, other profiles are also possible, for example rectangular profiles, such that an electrical contact with the respective areas is realized as described hereinabove. What is achieved by use of especially the second and third supplementary electrically conductive paths 122, 123 is that the respective areas OB, TB of the resistance track 110 that are in electrical contact with these paths have a practically constant electric tension. The supplementary electrically conductive paths 122, 123 function as bypasses.

As shown in FIG. 5A, the first supplementary electrical path 121 and the second supplementary electrical pad 122 are connected to the supply voltage Vcc. What is thereby achieved is that the voltage level in the overfold range OB is more or less constant, namely, approximately the supply voltage Vcc. The third supplementary electrical path 123 is connected via a third resistance R3 to electric ground Gnd. What is thereby achieved is that the voltage level in the intermediate range TB is also more or less constant, slightly above the level of electric ground Gnd. What is thereby achieved, in addition, is that the voltage level in the folding-out range UB increases from the level in the intermediate range TB to the level in the overfold range OB. The fourth supplementary electrical path 124 is directly connected to electric ground Gnd. What is thereby achieved is that the voltage level in the folding-in range IB increases from electric ground to the level in the intermediate range TB.

As represented in FIG. 5B, the voltage value or output voltage Vout1, as registered by the contact points 112, as a function of the pivoting angle h of the supporting frame 3, increases monotonically. In the folding-in range IB and the folding-out range UB, the output voltage Vout1 increases strictly monotonically, has an ascending flank throughout, so that each registered voltage value in the folding-in range IB and the folding-out range UB can be uniquely related to an associated pivoting angle of the supporting frame 3. By use of the supplementary electrically conductive paths 121-124, the output voltage in the intermediate range TB and the overfold range OB is practically constant so that a maximum voltage range can be realized in the folding-in range IB and the folding-out range UB. Thus, the position detector 100 has not only in the folding-out range UB but also in the folding-in range IB a greater sensitivity than in a range outside the folding-in range IB and the folding-out range UB. Here, advantageously, use is made of the nonlinear dependence of the voltage divider as a function of the pivoting angle of the supporting frame.

Specifically, a first curve segment C11 has near the second terminal point up to the folded-in position IS a practically constant profile V1. A second curve segment C12 linking up with the first curve segment C11 and corresponding to the folding-in range IB has a first slope or gradient. A third curve segment C13 linking up with the second curve segment C12 and corresponding to the intermediate range TB has a practically constant profile V2. A fourth curve segment C14 linking up with the third curve segment C13 and corresponding to the folding-out range UB has a second slope or gradient. A fifth curve segment C15 linking up with the fourth curve segment C14 and corresponding to the overfold range OB has a practically constant profile V3. The slope or gradient of the second curve segment C12 can be approximately as great as the slope or gradient of the fourth curve segment C14, but can also differ therefrom, depending on setting parameters, such as magnitude of the angular range of the folding-in range IB, the magnitude of the angular range of the folding-out range UB, and the resistance value of the third resistance R3.

Where the slope or gradient of the curve C is greater, a pivoting angle of the supporting frame 3 can be advantageously determined more accurately than in a segment where the slope is lower or absent altogether, formulated differently, where the gradient is lower or approaches zero, because a deviation of the pivoting angle in the steep curve segment brings about a relatively great change of the registered output voltage Vout. Thus, the nonlinear curve C can be optimized for accurately reading out an adjustment angle in a range that is relevant to the functioning of the device. Thus, an area in the resistance track 110 that substantially corresponds to the folding-in range IB and/or the overfold range OB is in electrical contact with an electrically conductive path 122, 123 which is connected directly, via an extra resistance track or via an electrical resistance, to an end 110a,b of the resistance track 110.

Also the second potentiometer 104′ includes supplementary electrically conductive paths 131, 132 which are in electrical connection with areas of the resistance track 110′. Thus, a fifth supplementary electrically conductive path 131 is near a first area 118 of the resistance track 110′ outside the angular range HB, beyond the first tilt limit angle KG1, and is in electrical contact at least with the greater part of said first area 118. Likewise, a sixth supplementary electrically conductive path 132 is near a second area 119 of the resistance track 110′ outside the angular range HB, beyond the second tilt limit angle KG2, and is in electrical contact at least with the greater part of said second area 119. The fifth supplementary electrical path 131 is connected to the supply line VCC, and the sixth supplementary electrical path 132 is connected to the electric ground GND. As a consequence, the output voltage Vout2 increases strictly monotonically only in the angular range HB, has an ascending flank only in the angular range HB, which is of benefit to the accuracy in the angular range.

FIG. 6A shows a schematic top view of a copper pattern on the supporting unit 103 of the position detector 100 of FIG. 5A. FIG. 6B shows a schematic top plan view of a carbon pattern on the supporting unit 103 of FIG. 6A. In addition, FIG. 6C shows a schematic perspective top view of the supporting unit 103 of FIG. 6A with copper pattern and carbon pattern.

During a manufacturing process of the position detector 100, the supporting unit 103 is provided with patterns. In a first step, a copper pattern 141 is applied, as shown in FIG. 6A. The copper pattern 141 includes electrically conductive paths and contact points, among which the above described guiding track 113 inclusive of terminal point P1 and supplementary electrical paths 121-124 with associated respective electrical terminal points P5, P4, P3, P2.

In a follow-on step, a carbon pattern 142 is applied onto the supporting unit 103 as shown in FIG. 6B. The carbon pattern 142 includes the resistance track 110 and the top layer of the guiding track 113. Thus, use is made of both a copper pattern 141 with material that has a relatively high electric conductivity, and a carbon pattern 142 with material that has a lower electric conductivity compared with copper. In principle, also other materials can be used with a mutually different electric conductivity.

In FIG. 6C the result is shown of the use of both the copper pattern 141 and the carbon pattern 142 on the supporting unit 103 of the position detector.

As may be clear, the device 1 can be provided on a vehicle, preferably a motor vehicle, such as, e.g., a car, a camper, bus or truck. The invention, furthermore, also relates to a vehicle provided with a device 1 as described herein.

In addition, the invention relates to a position detector 100 configured for use in a device 1 as described here, in particular a position detector configured for use in a device 1 as described here for adjusting a shell-shaped housing part, such as, for example a mirror cap, in particular a mirror device for a motor vehicle, wherein the position detector is configured for determining a pivoting position of the supporting frame 3 arranged on the base part 2 using a hinge construction 3, 25, 20, 60, 30, such that the supporting frame 3 is pivotable, in a pivoting range, relative to the base part 2 about a hinge axis 5 extending in a substantially upward direction, for instance using a, for example electric, actuator 4, between a folded-in position, in which the supporting frame 3, for instance, substantially abuts along the body of the motor vehicle, and at least one folded-out position, in which the supporting frame 3, for instance, is oriented transversely to the body, wherein the position detector comprises a voltage divider of which at least a part of the range substantially corresponds to the pivoting range of the supporting frame.

It is noted that for the purpose of clarity and a concise description elements or features have been described herein as part of the same or different exemplary embodiments and that the scope of the invention can comprise embodiments that comprise combinations of all or some of the elements or features described.

It will be clear that each of the devices shown and described and each element of the devices shown and described are also understood to have been described and shown separately and can also be used individually and/or in combination with at least one other element and are understood to have been described herein as such.

Thus, the position detector can include two supporting units, wherein each supporting unit is provided with a voltage divider. Also, extra functionality may be added to a supporting unit, for example, memory functionality.

Furthermore, it is noted that the invention is not limited to the exemplary embodiments described here. Many variants are possible.

Such variants will be clear to a person skilled in the art and are understood to be within the scope of the invention as defined in the appended claims.

1. A device for adjusting a shell-shaped housing part for a motor vehicle, the device comprising:
a base part, in for attachment to a body of the motor vehicle, on which, using a hinge construction a supporting frame is arranged, such that the supporting frame is pivotable in a pivoting range relative to the base part about a hinge axis extending in a substantially upward direction, for using a, first actuator, between a folded-in position, in which the supporting frame, substantially abuts along the body of the motor vehicle, and at least one folded-out position, the pivoting range including a folding-out range around the folded-out position, in which the supporting frame is oriented substantially transversely to the body, furthermore comprising a position detector for determining a pivoting position of the supporting frame relative to the base part, wherein the position detector comprises a first voltage divider of which at least a part of the range substantially corresponds to the pivoting range of the supporting frame.

2. The device according to claim 1, wherein the first voltage divider has a nonlinear dependency in the pivoting range of the supporting frame.

3. The device according to claim 1, wherein the position detector has a greater sensitivity in the folding-out range around the folded-out position than outside the folding-out range.

4. The device according to claim 1, wherein the position detector has a greater sensitivity in a folding-in range in the folded-in position and in the folding-out range than in a range outside the folding-in range and outside the folding-out range.

5. The device according to claim 1, wherein the first voltage divider comprises a potentiometer having a resistance track and a runner, coupled to the supporting frame or the base part, which is provided with a sliding contact which upon pivoting of the supporting frame moves in electrical contact along the resistance track.

6. The device according to claim 5, wherein the resistance track is circular segment-shaped or elongate.

7. The device according to claim 5, wherein the resistance track in an area substantially corresponding to the folding-out range around the folded-out position has a greater electrical resistance per unit length in a direction along the resistance track than in an area substantially corresponding to a range outside the folding-out range.

8. The device according to claim 5, wherein the resistance track in an area substantially corresponding to the folding-out range around the folded-out position has a smaller cross-sectional surface than in an area substantially corresponding to a range outside the folding-out range.

9. The device according claim 5, wherein material forming the resistance track in an area substantially corresponding to the folding-out range around the folded-out position has a lower electric conductivity than material in an area substantially corresponding to a range outside the folding-out range.

10. The device according to claim 1, wherein the pivoting range is such that the supporting frame is pivotable relative to the base part in the pivoting range between the folded-in position, in which the supporting frame, for instance, substantially abuts along the body of the motor vehicle, via the folded-out position, in which the supporting frame is oriented substantially transversely to the body, and an overfold position, in which the supporting frame is pivoted beyond the folded-out position.

11. The device according to claim 10, wherein an area substantially corresponding to a folding-in range adjacent to the folded-in position or an overfold range adjacent to the overfold position is in electrical contact with an electrically conductive path that is connected directly, via an extra resistance track or via an electrical resistance, to an end of the extra resistance track.

12. The device according to claim 5, wherein the potentiometer furthermore comprises a guiding track, and wherein the runner is provided with a pair of sliding contacts of which a first sliding contact, coupled to the supporting frame or the base part, upon pivoting of the supporting frame moves in electrical contact along the resistance track, and a second sliding contact, mechanically and electrically connected with the first sliding contact, upon pivoting of the supporting frame moves in electrical contact along the guiding track.

13. The device according to claim 1, wherein on the supporting frame a support, for supporting a mirror surface, is arranged using a second hinge construction such that the support is pivotable relative to the supporting frame using a second actuator, wherein said support is pivotable relative to the supporting frame only about a second hinge axis extending substantially transversely to the substantially upward direction, and wherein the position detector comprises a second voltage divider for determining a pivoting position of the support relative to the supporting frame.

14. The device according to claim 13, wherein the position detector comprises a supporting unit, for instance implemented as a printed circuit board, on which the first voltage divider and the second voltage divider are arranged.

15. A position detector configured for use in the device according to claim 1 for adjusting the shell-shaped housing part, wherein the position detector is configured for determining the pivoting position of the supporting frame which, using a hinge construction is arranged on the base part, such that the supporting frame is pivotable in a pivoting range relative to the base part about a hinge axis extending in a substantially upward direction using an actuator, between a folded-in position, in which the supporting frame, substantially abuts along the body of the motor vehicle, and at least one folded-out position, in which the supporting frame is oriented substantially transversely to the body, wherein the position detector comprises a first voltage divider of which at least a part of the range substantially corresponds to the pivoting range of the supporting frame.

16. A vehicle provided with the device according to claim 1.

17. The device according to claim 1, wherein the shell-shaped housing part is a mirror device for the motor vehicle.
